(19) United States
(12) Patent Application Publication
(10) Pub. No.: US 2021/0069831 A1
(43) Pub. Date: Mar. 11, 2021

(54) SYSTEM AND METHOD FOR MINIMIZING THE EFFECTS OF SENSOR ORIENTATION IN SMART OPTICAL MONITORING SYSTEMS

(71) Applicant: Sensigma LLC, Ann Arbor, MI (US)

(72) Inventors: Joohyun Choi, West Bloomfield, MI (US); Jyotirmoy Mazumder, Ann Arbor, MI (US)

(73) Assignee: Sensigma LLC, Ann Arbor, MI (US)

(21) Appl. No.: 17/018,969

(22) Filed: Sep. 11, 2020

Related U.S. Application Data
(60) Provisional application No. 62/898,617, filed on Sep. 11, 2019.

(51) Int. Cl. B23K 26/342; G01N 21/71; G01N 21/73; G01N 21/25; G01J 3/443; B33Y 30/00; B33Y 50/00; B23K 26/00; B23K 26/06; B23K 26/067; B23K 26/14

(52) U.S. Cl. CPC B23K 26/342; G01N 21/718; G01N 21/73; G01N 21/25; G01J 3/443; B33Y 30/00; B23K 26/1464; B23K 26/0006; B23K 26/0604; B23K 26/0643; B23K 26/0665; B23K 26/0676; B33Y 50/00

(57) ABSTRACT

A smart additive manufacturing system uses a spectrometer to collect emission spectra along an optical axis from a laser-generated plasma plume, and wherein the laser beam and the optical axis of the emission spectra are co-axial, at least in the vicinity of the melt pool, thereby minimizing the fluctuation of spectral signals caused by ambient pressure/gas variations. The laser beam passes through a beam splitter prior to reaching the work piece, and the emission spectra from the work piece are redirected by the beam splitter to the spectrometer, and wherein the laser beam and the optical axis of the emission spectra are co-axial between the work piece and the beam splitter. The beam splitter may be a dichroic mirror or other type of beam splitter, including holographic beam splitters, and spectral filtering may be carried out with separate optical elements, as long as the overall goal of on-axis excitation and collection is achieved.

### REFERENCE TO RELATED APPLICATIONS

This application claims priority to and the benefit of U.S. Provisional Patent Application Ser. No. 62/898,617, filed Sep. 11, 2019, the entire content of which is incorporated herein by reference.

### FIELD OF THE INVENTION

This invention relates generally to additive manufacturing (AM) and, in particular, to a smart AM system that uses an improved, co-axial laser/sensor path smart optical monitoring system (SOMS).

### BACKGROUND OF THE INVENTION

Additive manufacturing (AM) has been hailed as the “third industrial revolution” by Economist magazine (April 2012). Additive Manufacturing (AM) builds up a material to suit the service performance in a layer by layer, or even pixel by pixel with appropriate materials to match the performance, which will enhance the productivity and thus reduce energy consumption. Flexibility and capability of producing near net shape critical components directly from Computer Aided Design (CAD) is partly responsible for its attraction.

There is wide spectrum of processes under the umbrella of Additive manufacturing. For metallic components two main types are: Powder-bed-based processes, such as Selective Laser Sintering (SLS), and pneumatically delivered powder-based processes such as Direct Metal Deposition (DMD). Both processes have their relative strength and weaknesses. One common problem is that post process quality assurance is not adequate. However, on-line diagnostics and process control have the tremendous potential to reduce waste, cost and conserve energy. This offers a unique opportunity to take corrective action during AM—layer by layer, if not pixel by pixel.

### SUMMARY OF THE INVENTION

This invention improves upon laser-based additive manufacturing (AM) in general, and direct-metal deposition (DMD) in particular by providing an improved smart optical monitoring system (SOMS) and method. An additive manufacturing system according to the invention includes a laser outputting a beam of light onto work piece so as to form a melt pool with a laser-generated plasma plume, and a spectrometer operative to collect emission spectra along an optical axis from the laser-generated plasma plume. However, unique to the invention, the laser beam and the optical axis of the emission spectra are co-axial, at least in the vicinity of the melt pool, thereby minimizing the fluctuation of spectral signals caused by ambient pressure/gas variations.

In accordance with a preferred embodiment, the laser beam passes through a beam splitter prior to reaching the work piece, the emission spectra from the work piece are redirected by the beam splitter to the spectrometer, and the laser beam and the optical axis of the emission spectra are co-axial between the work piece and the beam splitter. The beam splitter may be a dichroic mirror or other type of beam splitter, including holographic beam splitters, and spectral filtering may be carried out with separate optical elements, as long as the overall goal of on-axis excitation and collection is achieved.

The beam splitter may be fabricated or selected to function as a short-pass or as a long-pass filter based on the type of material comprising the work piece or a desired wavelength range of the emission spectra. An optical element disposed between the beam splitter and the melt pool may be used to focus the laser beam onto the work piece and/or to collimate the on-axis spectra collected from the laser-induced plume.

The additive manufacturing system may comprise a laser or arc welding system, a powder-bed fusion (PBF) system or other type of DMD system.

### BRIEF DESCRIPTION OF THE DRAWINGS

FIG. 1(a) is a drawing of a typical AM-Direct Energy Deposition (DED) system;

FIG. 1(b) depicts a comparison of a laser generated plasma plume at varying pressures;

FIG. 2 provides an example of effect on sensor orientation to sensor signal intensity by SOMS in the case of circular cylinder build-up;

FIG. 3(a) is a schematic of a coaxial set-up of an optics train with SOMS;

FIG. 3 (b) shows the selection of a dichroic mirror with a SOMS sensor;

FIG. 4 is an example of a SOMS set-up with a commercially available laser head; and

FIG. 5 illustrates a co-axial optic train SOMS set-up for a 3DP powder bed fusion system.

### DETAILED DESCRIPTION OF THE INVENTION

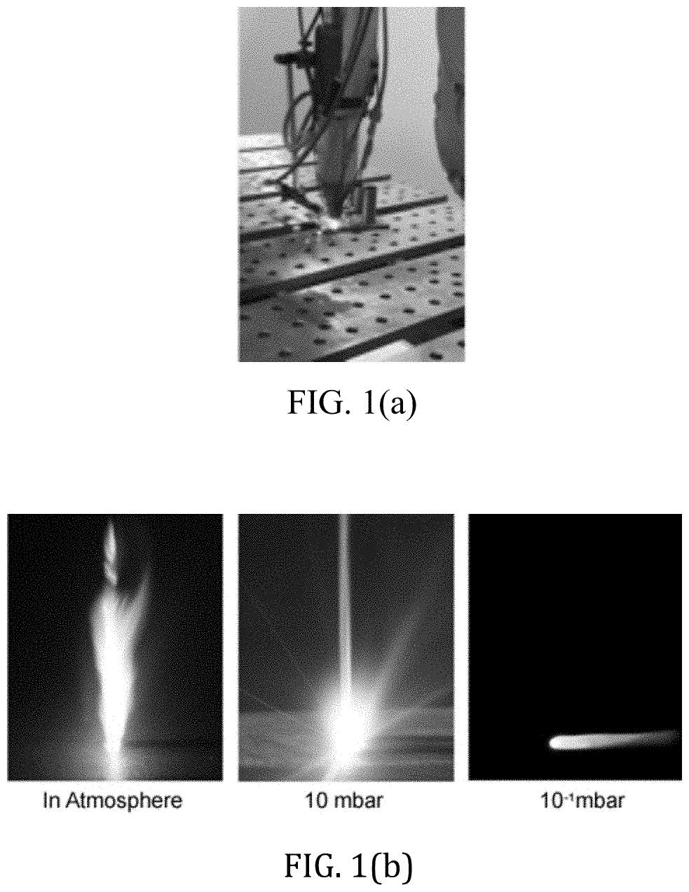

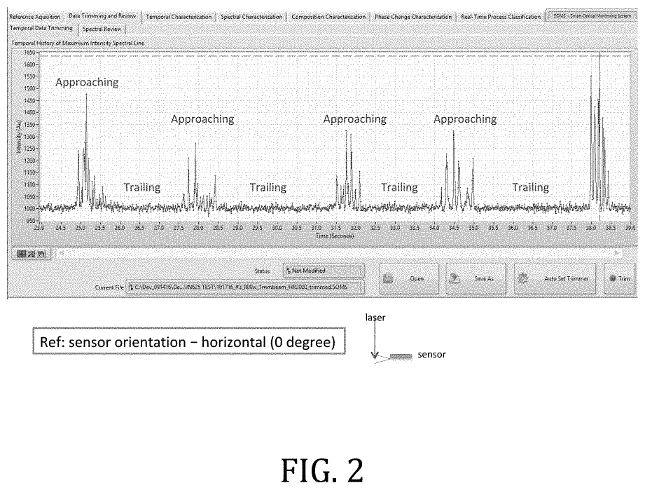

To increase the accuracy of additive manufacturing (AM) in general, and direct-metal deposition (DMD); directed-energy deposition (DED); and powder-bed deposition systems in particular, a spectroscopic sensor may be used to achieve a Smart Optical Monitoring System (SOMS). This equipment, shown in FIG. 1(a), addresses many of the challenges faced by manufacturing industries, including stringent customer demands, intensified competition to reduce lead time, cycle time and manual labor, and rigorous requirements to eliminate liability of defective products.

SOMS uses optical emission spectroscopy to improve manufacturing quality to achieve no-defect product throughput in metal manufacturing processes, especially laser/arc welding and additive manufacturing (AM) processes. SOMS has the ability to perform in-situ characterization of defects such as porosity, composition, and phase transformation for fabrication processes using emitted light without any physical contact.

Atomic-level information unraveling, and mechanical and chemical condition of the product are also provided by SOMS. Spectroscopic sensors exhibit remarkable immunity to both electromagnetic interference and background acoustic noises associated with the fabrication processes.

In SOMS, an optical collimator collects the plasma plume emission from the processing zone and sends the signal to a spectrometer for signal processing. The spectrometer has a tunable optical attenuator to adjust the signal intensity to avoid saturation. The plasma spectra obtained from the spectrometer are analyzed in a signal processing unit, where mechanisms on how different defects, composition and phase transformation affect the plasma characterization are analyzed. A refined signal processing algorithm is used to detect and categorize different defects, analyze composition and phase transformation and predict the cause of these changes.

Some AM systems require processing under specific ambient environments (inert gas or near vacuum). It is noted that the laser-generated plasma plume size varies depending on the type of ambient gas and pressure, as shown in FIG. 1(b). In near-vacuum conditions, the laser generated plasma plume may exhibit a near-spherical shape, varying under types of ambient gas (e.g., He, N, Ar, etc.) and pressure.

In minimizing the fluctuation of spectral signals caused by ambient pressure/gas variation, machine-trained SOMS data needs to be properly captured and executed. Indeed, it has been discovered that the plasma spectrum intensity measured by the spectrometer may vary due to sensor orientation and/or angle. However, it has also been found that the consistency of the spectral signals can be maintained through proper sensor orientation. In broad and general terms, to minimize the influence of motion variation and sensor orientation to sensor signal intensity during SOMS, this invention uses a co-axial arrangement of the sensor with respect to the laser plasma plume.

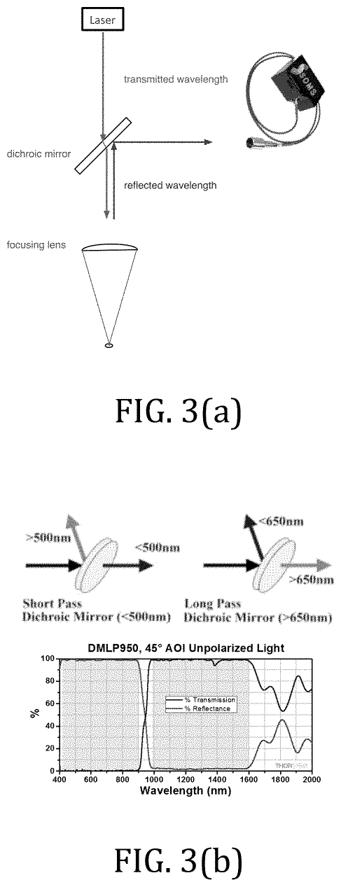

A co-axial set-up of the SOMS sensor with respect to optical train inside the laser head is shown in FIG. 3(a). A laser used for deposition and/or plume analysis, passes through a beam splitter and is focused onto a localized region of a work piece. The reflected wavelengths are redirected by the same beam splitter onto the spectroscopic sensor shown at the right in the diagram. It is noted that other types of beam splitters may be used, including holographic, and the filtering may be done with separate optical elements, as long as the overall goal of on-axis excitation and collection is maintained.

In the embodiment shown, the spectroscopic signals are acquired by way of a dichroic mirror to the SOMS sensor. The selection of dichroic mirror (short-pass or long-pass) is dependent on the types of material (metals or polymers) to be processed and atomic data (strong lines or persistent lines) of major elements to be detected as shown in FIG. 3(b). In particular, a short-pass filter may be implemented to pass wavelengths less than 500 nm, while reflecting wavelengths greater than 500 nm, whereas a long-pass arrangement may be used to pass wavelengths greater than 650 nm, while reflecting wavelengths less than 650 nm. Those of skill in the art will appreciate that other filters may be used to pass and/or reflect wavelengths of interest.

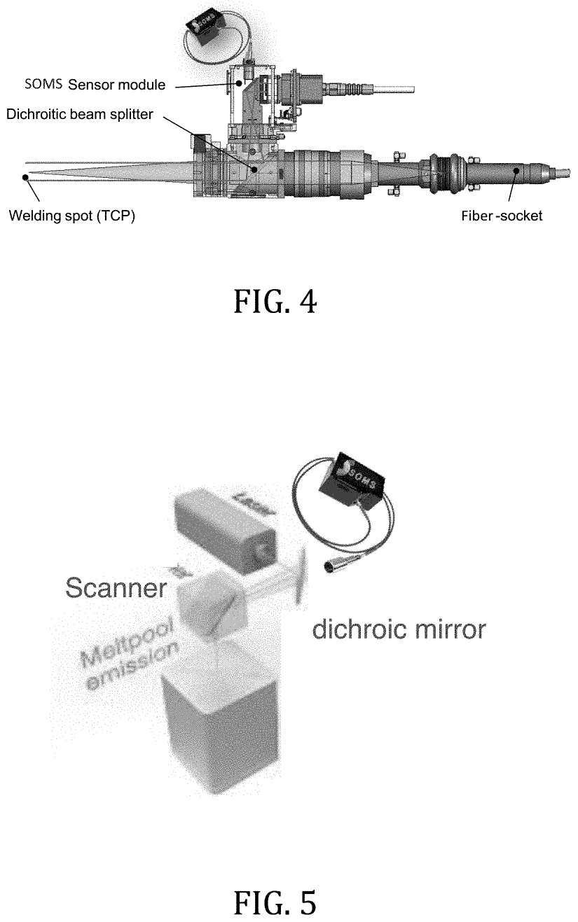

As an example of SOMS sensor set-up with a commercially available laser head, co-axial sensing through optics train can be done, as shown in FIG. 4. As one specific application example, FIG. 5 depicts an optical train integration of a SOMS sensor with powder-bed fusion (PBF) AM system.

1. An additive manufacturing system, comprising:
a laser outputting a beam of light onto work piece so as to form a melt pool with a laser-generated plasma plume;
a spectrometer operative to collect emission spectra along an optical axis from the laser-generated plasma plume; and
wherein the laser beam and the optical axis of the emission spectra are co-axial at least in the vicinity of the melt pool.

2. The additive manufacturing system of claim 1, wherein:
the laser passes through a beam splitter prior to reaching the work piece;
the emission spectra from the work piece are redirected by the beam splitter to the spectrometer; and
the laser beam and the optical axis of the emission spectra are co-axial between the work piece and the beam splitter.

3. The system of claim 1, wherein the beam splitter is a dichroic mirror.

4. The system of claim 1, wherein the beam splitter is selected to function as a short-pass or as a long-pass filter.

5. The system of claim 1, wherein the choice of a short-pass or a long-pass filter is based on the type of material comprising the work piece.

6. The system of claim 1, wherein the choice of a short-pass or a long-pass filter is based on a wavelength range of the emission spectra.

7. The system of claim 1, further including an optical element between the beam splitter and the melt pool to focus the laser beam onto the work piece.

8. The system of claim 1, wherein the additive manufacturing system is a laser or arc welding system.

9. The system of claim 1, wherein the additive manufacturing system is a powder-bed fusion (PBF) system.

10. In a smart optical monitoring system wherein a spectrometer is used to collect emission spectra from a laser-generated plasma plume, the improvement comprising:
a beam splitter disposed in the path of the laser operative to re-direct the emission spectra to the spectrometer, such that the path of the transmitted laser wavelength and the path of the reflected wavelengths to the sensor are co-axial.

11. The improvement of claim 10, further including a focusing objective between the beam splitter and a sample melt pool.

12. The improvement of claim 10, wherein the beam splitter is a dichroic mirror.

13. The improvement of claim 10, wherein the beam splitter is selected to function as a short-pass or as a long-pass filter.

14. The improvement of claim 10, wherein the choice of a short-pass or a long-pass filter is based on the type of material being monitored.

15. The improvement of claim 10, wherein the choice of a short-pass or a long-pass filter is based on the atomic data of elements to be detected.

16. The improvement of claim 10, wherein the smart optical monitoring system forms part of an additive manufacturing system.

17. The improvement of claim 10, wherein the smart optical monitoring system forms part of a laser/arc welding system.

18. The improvement of claim 10, wherein the smart optical monitoring system forms part of a powder-bed fusion (PBF) system.
